(19) United States
(12) Patent Application Publication
(10) Pub. No.: US 2008/0110295 A1
(43) Pub. Date: May 15, 2008

(54) Transmission case

(75) Inventors: Toshihiko Aoki, Anjo (JP); Toshiyuki Miyoshi, Anjo (JP); Kazutoshi Omagari, Anjo (JP); Minoru Todo, Takahama (JP); Mikio Iwase, Anjo (JP); Yoshihiro Takigawa, Tsushima (JP); Takayuki Kamei, Anjo (JP); Takashi Ando, Nishio (JP); Atsushi Honda, Seto (JP); Kazutoshi Nozaki, Togo (JP); Wataru Nagata, Komaki (JP)

Correspondence Address: OLIFF & BERRIDGE, PLC, P.O. BOX 320850, ALEXANDRIA, VA, 22320-4850, US

(73) Assignees: AISIN AW CO., LTD., ANJO-SHI (JP); TOYOTA JIDOSHA KABUSHIKI KAISHA, TOYOTA-SHI (JP)

(21) Appl. No.: 11/979,923

(22) Filed: Nov. 9, 2007

(30) Foreign Application Priority Data
Nov. 10, 2006 (JP) 2006-306020

(51) Int. Cl. F16H 57/04; B21B 1/46

(52) U.S. Cl. 74/606 R; 29/527.5

(57) ABSTRACT

A transmission case includes a power transmission mechanism; a first case body and an adapter portion. The adapter portion includes a boss portion through which the output shaft is inserted, a first concave portion provided on an outer peripheral side of the boss portion and open rearward in the shaft direction, which is on the power output side of the power transmission mechanism, and a second concave portion open outward in a radial direction of the boss portion with the second concave portion separated in the shaft direction from the first concave portion by a separating wall.

### INCORPORATION BY REFERENCE

The disclosure of Japanese Patent Application No. 2006-306020, filed on Nov. 10, 2006, including the specification, drawings and abstract is incorporated herein by reference in its entirety.

### BACKGROUND

The present invention relates to a transmission case.

A transmission, which is a type of vehicle-mounted power transmission system, is provided with a transmission case (hereinafter abbreviated as a T/M case) that houses a power transmission mechanism and that stores automatic transmission fluid (ATF) that is used as hydraulic fluid and lubricating fluid. The T/M case must be lightweight, strong and oil-tight. The T/M case is thus generally manufactured by casting using an aluminum alloy die-casting method.

For a transmission mounted on a four-wheel drive vehicle, a transfer is added thereto for distributing a driving force from the transmission to the front and rear wheels. Therefore, a transfer case housing the transfer is joined and fixed to a rear end of the T/M case with an adapter therebetween, which is provided in a separate body. Recently, in order to reduce the number of assembled parts, a T/M case is designed with an adapter formed integrally at a rear end side thereof (see JP-A-2003-329116 for example).

### SUMMARY

When an adapter portion is formed integrally with a T/M case, if only a through-hole is formed for inserting the output shaft of a power transmission mechanism through the adapter portion, the T/M case increases in weight by the weight of the adapter portion. There is therefore a concern that the workability is reduced while assembling the transmission. It may be considered therefore that a concave portion is formed for reducing the thickness of the adapter portion so as to reduce the weight.

In order to reduce weight, as in the T/M case described in JP-A-2003-329116, a shaft direction concave portion open in the rearward shaft direction of the output shaft of a power transmission mechanism may be formed at an adapter portion of a T/M case. When a shaft direction concave portion is formed in order to reduce weight sufficiently, however, the depth of the shaft direction concave portion is elongated along the output shaft direction. Therefore, the core of a forming die for forming the shaft direction concave portion is also elongated as an inevitable consequence. As a result, it is difficult, from a view point of core strength, to provide a cooling passage long enough to reach near a distal portion in such an elongated core. Therefore, at the time of die-cast molding, an area adjacent to an inner base surface of the shaft direction concave portion is not cooled sufficiently and thus experiences seizure. As a result, there may be a problem in forming a casting cavity in the area adjacent to the inner base surface of the shaft direction concave portion in the adapter portion of the T/M case.

From a view point of die cutting, it is required that an inner surface of the shaft direction concave portion is a taper surface spreading toward the die cutting direction, with the result that the cross sectional area of the shaft direction concave portion becomes smaller from the opening side to the inner base surface side. Thus, there has been a problem that the inner surface of the shaft direction concave portion in the adapter portion tends to have, in an area adjacent to the inner base surface thereof, a thick part formed and a casting cavity. It has been a problem in that, if there is such a casting cavity formed, then the oil-tightness is diminished.

The present invention thus provides, among other things, a transmission case in which the weight may be reduced while retaining enough strength and oil-tightness even with an adapter portion formed integrally with an edge thereof.

A transmission case that is capable of housing a power transmission mechanism that includes an output shaft that extends along a shaft direction, according to an exemplary aspect of the invention, includes a first case body having a cylindrical shape along the shaft direction with the power transmission mechanism capable of being housed in the first case body; and an adapter portion integrally formed with the first case body that is capable of connecting with a second case body at a rear end of the first case body, which is on a power output side of the power transmission mechanism. The adapter portion includes a boss portion through which the output shaft is inserted, a first concave portion provided on an outer peripheral side of the boss portion and open rearward in the shaft direction, which is on the power output side of the power transmission mechanism, and a second concave portion open outward in a radial direction of the boss portion with the second concave portion separated in the shaft direction from the first concave portion by a separating wall.

A method of forming a transmission case with a first case body having a cylindrical shape and an adapter portion integrally formed with the first case body that is capable of connecting with a second case body at a rear end of the first case body, according to an exemplary aspect of the present invention includes moving a front forming die relative to a rear forming die; moving an upper forming die relative to the front forming die and the rear forming die; and filling a cavity formed by the front forming die, the rear forming die and the upper forming die in order to form a boss portion, a first concave portion provided on an outer peripheral side of the boss portion and open rearward, and a second concave portion open outward in a radial direction of the boss portion with the second concave portion separated from the first concave portion by a separating wall.

A case according to an exemplary aspect of the present invention includes a first case body having a cylindrical shape; and an adapter portion integrally formed with the first case body that is capable of connecting with a second case body at a rear end of the first case body. The adapter portion includes a boss portion, a first concave portion provided on an outer peripheral side of the boss portion and open rearward, and a second concave portion open outward in a radial direction of the boss portion with the second

### BRIEF DESCRIPTION OF THE DRAWINGS

Various exemplary embodiments will be described with reference to the drawings, wherein:

FIG. 1 is a sectional view illustrating a main part of a T/M case rear end according to a first embodiment;

FIG. 2 is a plan view illustrating the main part;

FIG. 3 is a bottom view illustrating the main part;

FIG. 4 is a front view illustrating the main part;

FIG. 5 is a left side view illustrating the main part;

FIG. 6 is a sectional view illustrating a mold clamping state of forming dies;

FIG. 7 is a sectional view illustrating a mold opening state of forming dies;

FIG. 8 is a plan view illustrating a main part of a T/M case rear end according to a second embodiment; and

FIG. 9 is a front view illustrating the main part.

### DETAILED DESCRIPTION OF EMBODIMENTS

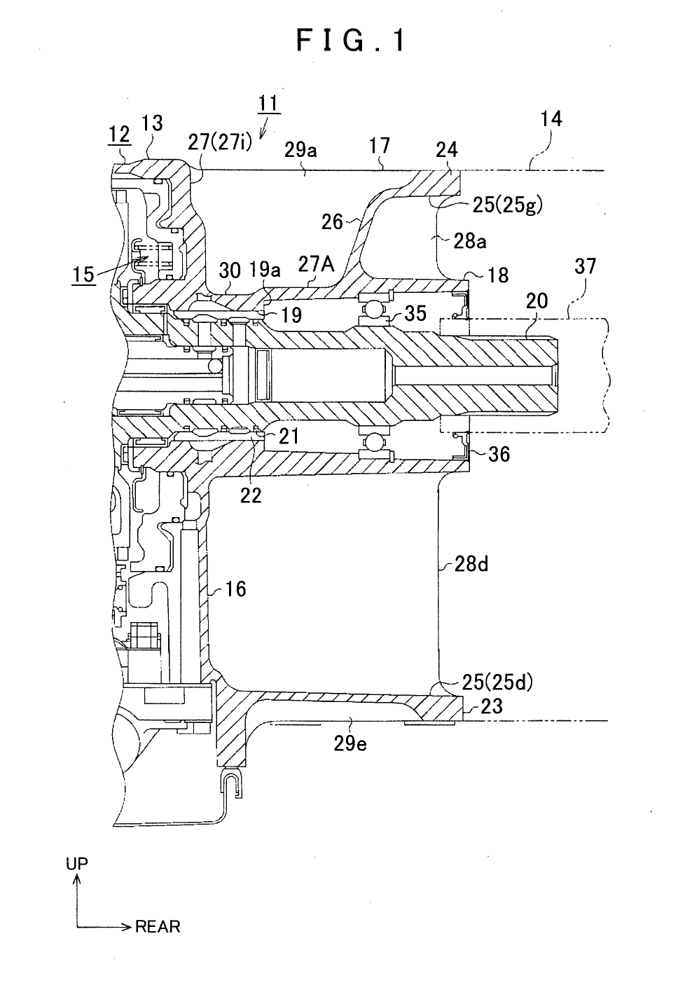

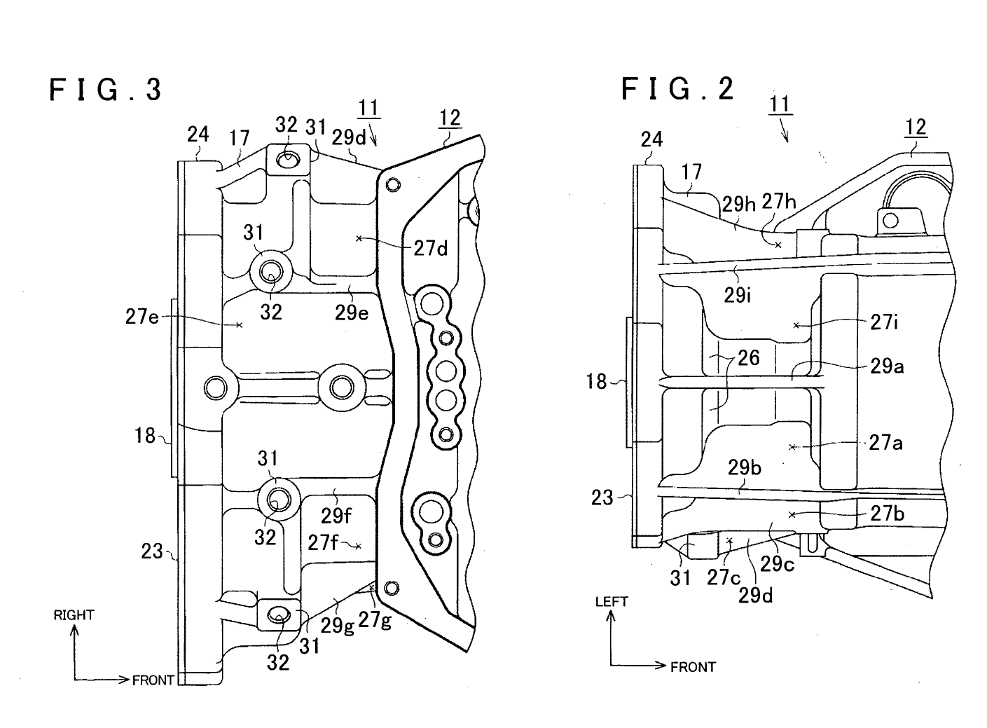

Referring to the FIGS. 1 to 7, a first embodiment applying the present invention to a transmission case (hereinafter referred to as a T/M case) housing therein a power transmission mechanism (hereinafter referred to as an automatic transmission) that is a type of vehicle-mounted power transmission system will be described below. It should be noted that when a “forward-rearward direction”, a “left-right direction”, or a “upper-lower direction” is indicated in the following description, the direction specified by the arrows in the diagrams are denoted unless specifically indicated. “Forward” denotes the direction toward the power input side of a power transmission mechanism, and “rearward” denotes the direction toward the power output side thereof.

As shown in FIG. 1, an automatic transmission 11 as a vehicle-mounted power transmission system according to the present embodiment is provided with a T/M case 12 that is cast by aluminum die-cast molding into a substantially cylindrical shape having a bottom. In the T/M case 12, a power transmission mechanism 15 is housed that has a shift transmission unit including a plurality of friction engagement devices, planetary gear units, and the like. It should be noted that FIG. 1 is a cutaway view of only the rear end of the T/M case 12.

As shown in FIG. 1, the T/M case 12 has a case body 13 (which is an example of a first case body) that serves as a main body housing the power transmission mechanism 15, and at a rearward side of a rear end wall 16 of the case body 13, an adapter portion 17 is formed integrally. The adapter portion 17 is a portion for connecting an other case (for example a transfer case) 14 (which is an example of a second case body) to a rear end of the T/M case 12 that is on the power output side of the power transmission mechanism 15, as shown by an alternate long and two short dashes line in FIG. 1. At a substantial center portion, a boss portion 18 with a cylindrical shape extends (i.e., protrudes) rearward from the rear end wall 16 of the case body 13. In a deep interior of a circumference of the boss portion 18, which is on the side of case body 13, a through-hole 19 is formed penetrating through the rear end wall 16 of the case body 13 in the front-and-back direction. An output shaft 20 of the power transmission mechanism 15 is inserted through the through-hole 19 via an oil seal 21 and a sleeve.

In the inner circumference of the boss portion 18, the location in which the through-hole 19 is formed has a smaller diameter because of a shoulder 19a that protrudes further inwardly in the radial direction than in other locations. A bearing 35 is disposed in the inner circumference of the boss portion 18 that is more rearward in the shaft direction than the shoulder 19a through which the through-hole 19 is formed. The output shaft 20 protrudes at its rear end rearward from inside the boss portion 18 with the output shaft 20 inserted through the bearing 35. Moreover, a seal member 36 for rendering oil-tight a space between the boss portion 18 and the output shaft 20 that is inserted through the boss portion 18 is attached at a position more rearward in the shaft direction than the bearing 35 in the inner circumference of the boss portion 18 (more specifically to an inner circumferential edge of the boss portion 18). In the present embodiment, as shown by the alternate long and two short dashes lines in FIG. 1, the seal member 36 is adapted to be in close contact with an outer circumference surface of a connecting shaft 37 that is connected to the output shaft 20 by protruding from the other case 14 side connected to the adapter portion 17.

As shown in FIGS. 1 and 5, in the adapter portion 17, a cylindrical portion 24 that is adapted to define an exterior shape of a joint surface (the left end surface in FIG. 1) 23 for joining the other case 14 thereto and has an irregular shape is extended rearward from an outer circumference of the rear end wall 16 of the case body 13. Between the inner circumference of the cylindrical portion 24 and the outer circumference of the boss portion 18, a first concave protrusion 25 is formed that is open toward a rearward side in the shaft direction that is on a power output side of the power transmission mechanism 15. A second concave portion 27 that is open outward in the radial direction of the boss portion 18 is also formed at a location more forward in the shaft direction than the cylindrical portion 24 on an outer circumference side of the adapter portion 17, in a state that the first concave portion 25 and the second concave portion 27 are separated in the shaft direction with a separating wall 26 therebetween and the second concave portion 27 has an inner base surface 27A formed by the outer circumference of the boss portion 18.

As shown in FIGS. 1 and 5, a plurality of ribs 28a to 28g, each connecting between the boss portion 18 and the cylindrical portion 24, are formed in the first concave portion 25 of the adapter portion 17 in a state that each of the ribs 28a to 28g extends along a radial direction about the through-hole 19. Each of the ribs 28a to 28g is thus extended along the shaft direction. The ribs 28a to 28g thereby define in the first concave portion 25 a plurality of shaft direction concave portions 25a to 25g in the circumferential direction of the boss portion 18.

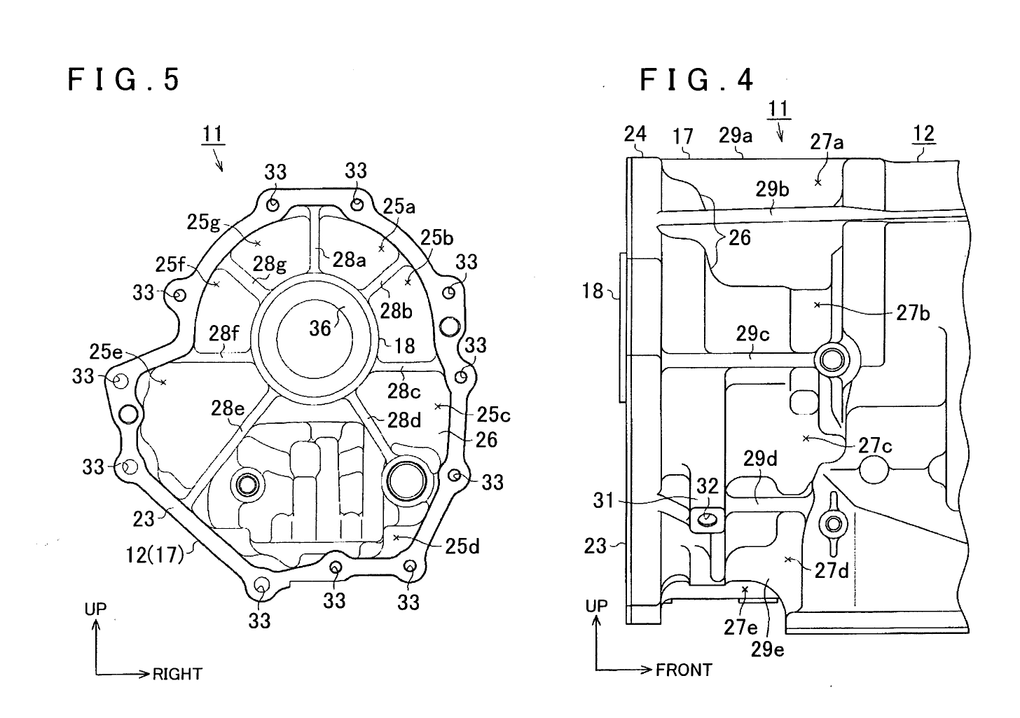

As shown in FIGS. 1 to 4, a plurality of ribs 29a to 29d and 29g to 29i are formed in the second concave portion 27 of the adapter portion 17, where the ribs 28a to 28g dividing the first concave portion 25 and the ribs 29a to 29d and 29g to 29i are correspondingly located in the circumferential direction of the boss portion 18 with the separating wall 26 therebetween as a border. Each of the ribs 29a to 29d and 29g to 29i extends from the outer circumference of the boss portion 18 along the radial direction about the through-hole 19. As shown in FIG. 4, in the second concave portion 27, a left and right pair of ribs 29e and 29f extending in parallel to each other from the outer circumference of the boss portion 18 to the downward vertical direction are formed on a lower side of the adapter portion 17. It should be noted that each of the left and right pair of ribs 29e and 29f has a shape in which a bottom edge thereof is notched in a substantial U-shape toward the upper direction. Each of the ribs 29a to 29i is thus extended along the shaft direction, and thereby in the second concave portion 27 a plurality of radial direction concave portions 27a to 27i are defined in the circumferential direction of the boss portion 18.

Therefore, the thickness of the adapter portion 17, which is formed integrally with the rear end of the T/M case 12, is reduced by each of the shaft direction concave portions 25a to 25g that constitute the first concave portion 25 and by the radial direction concave portions 27a to 27i that constitute the second concave portion 27, and thereby the weight of the T/M case 12 is reduced by the concave portions 25, 25a to 25g, 27, and 27a to 27i. In the adapter portion 17, the strength of the T/M case 12 is enhanced by each of the ribs 28a to 28g that are defined in the first concave portion 25, by each of the ribs 29a to 29i that are defined in the second concave portion 27, and by the separating wall 26 that separates between the first concave portion 25 and the second concave portion 27.

As shown in FIG. 1, at the inner base surface 27A of the radial direction concave portions 27a to 27i (in FIG. 1, only the radial direction concave portion 27i is shown) that constitute the second concave portion 27, a thinning portion 30 is also formed with a shape that generally corresponds to that of the area where the through-hole 19 and the shoulder 19a are formed in the inner circumference of the boss portion 18. In other words, the inner base surface 27A of the radial direction concave portions 27a to 27i that constitute the second concave portion 27 is formed so that a thick part is not partially formed, and the thickness is substantially the same as that of the boss portion 18.

As shown in FIGS. 3 and 4, on a lower side of the adapter portion 17, a plurality of mount bosses 31 are also formed (i.e., protrude) that are used for attaching the T/M case 12 to a vehicle body. Each of the mount bosses 31 is provided with a bolt hole 32 by drilling, and via the mount bosses 31 the T/M case 12 is mounted and fixed by bolting to the vehicle body. As shown in FIG. 5, on the joint surface 23 of the adapter portion 17, a plurality of bolt holes 33 are formed that are used to insert bolts therethrough for connecting the other case 14 such as a transfer case thereto.

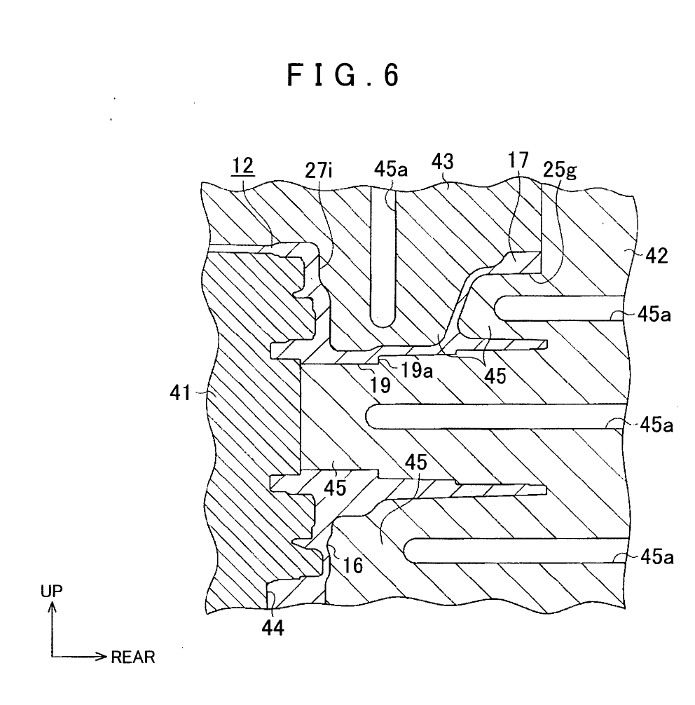

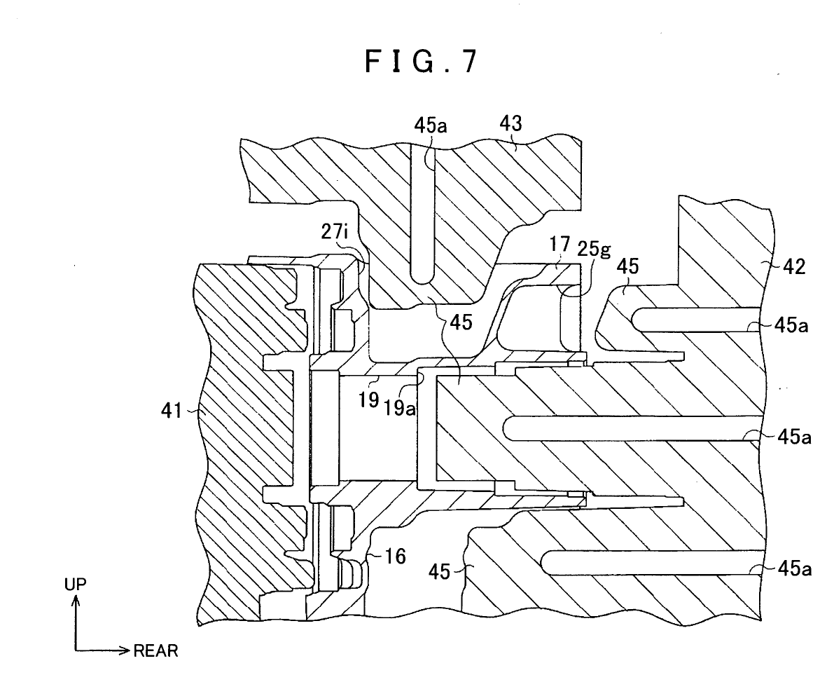

Next, referring to FIGS. 6 and 7, a manufacturing method by a die-cast method of the T/M case 12 according to the present embodiment as structured above will be described. It should be noted that in FIGS. 6 and 7, an adjacent area of each of the shaft direction concave portion 25g and the radial direction concave portion 27i on an upper side of the adapter portion 17 is illustrated partially in sectional views.

As shown in FIG. 6, forming dies used for molding the T/M case 12 include a front forming die 41 that is moved from a forward side to a rearward side at a time of die matching, a rear forming die 42 that is moved from a rearward side to a forward side, an upper forming die 43 that is moved from an upper side to a lower side, a lower forming die that is not shown and is moved from a lower side to a upper side, and left- and right-side forming dies that are moved in left and right directions. By die matching these six forming dies, a cavity 44 is formed with a shape that corresponds to that of the T/M case 12. By parting the forming dies as shown in FIG. 7, after filling the cavity 44 with a molten aluminum alloy and cooling and hardening the molten aluminum alloy within the forming dies, the T/M case 12 having a rear end integrally provided with the adapter portion 17 is molded.

Within a core 45 that protrudes forward from the rear forming die 42 for forming the boss portion 18 that houses the through-hole 19 therein and the shaft direction concave portion 25g, a cooling passage 45a reaching an adjacent area of a distal portion of the core 45 is provided for cooling the core 45. Similarly, within a core 45 that protrudes downward from the upper forming die 43 for forming the radial direction concave portion 27i, a cooling passage 45a reaching an adjacent area of a distal portion of the core 45 is provided for cooling the core 45. Since the cooling passage 45a reaches an adjacent area of the distal portion of the core 45, even at a time of filling the molten metal into the cavity 44, the core 45 can be sufficiently cooled. Consequently, in the T/M case 12, the rear end wall 16 of the case body 13, the through-hole 19 of the adapter portion 17, and a peripheral portion of the separating wall 26 are sufficiently cooled, with a result that forming of any seizure in these portions is suppressed and thus forming of a casting cavity in the case body 13 of the molded T/M case 12 and the adapter portion 17 thereof is suppressed.

Therefore, according to the present embodiment, the following advantageous effects are obtained.

(1) In the adapter portion 17 that is formed integrally with the rear end of the T/M case 12, the first concave portion 25 open rearward in the shaft direction that is on the power output side, and the second concave portion 27 open outward in the radial direction of the boss portion 18 are separated from each other with the separating wall 26 therebetween. Consequently, in the adapter portion 17, the concave portions 25 and 27 form a large empty space, with a result that a weight increase caused by integrally forming the adapter portion 17 is reduced by a portion corresponding to the empty space. Specifically, in the adapter portion 17, a portion other than the boss portion 18, the separating wall 26, and the cylindrical portion 24 is a thinning portion such as the first concave portion 25 and the second concave portion 27, with a result that the weight is efficiently reduced for convenient handling.

(2) By having the first concave portion 25 open rearward in the shaft direction and the second concave portion 27 open outward in the radial direction together, in reducing the weight of the T/M case 12, it is not required that the first concave portion 25 is formed deep in the shaft direction, unlike a conventional case in which only a concave portion open rearward in the shaft direction is formed. Therefore, at the time of die-cast molding, forming of a casting cavity at an adjacent area of the inner base surface of the first concave portion 25 is suppressed, and thus the weight of the TIM case 12 can be reduced while predetermined strength and oil-tightness thereof are retained.

(3) There is an advantage in that, when forming the second concave portion 27 open outward in the radial direction of the boss portion 18, by adjusting the length of the core 45 for forming the second concave portion 27, a depth and an interior shape of the second concave portion 27 are formed optionally as desired.

(4) Cores 45 of the dies (the rear forming die 42 and the upper forming die 43) used for forming the concave portions 25 and 27 may also be applied, however, even if they are short, unlike the case in which only a concave portion open rearward in the shaft direction is formed, therefore a thick part is hardly formed at an adjacent area of the inner base surface in the inner surface of each of the concave portions 25 and 27, and also in this regard, forming of a casting cavity in the T/M case 12 and the adapter portion 17 can be reduced.

(5) In the T/M case 12, by the ribs 28a to 28g that divide the first concave portion 25 into the plurality of shaft direction concave portions 25a to 25g and by the ribs 29a to 29i that divide the second concave portion 27 into the plurality of radial direction concave portions 27a to 27i, the strengths of the T/M case 12 and of the adapter portion 17 thereof can be enhanced.

(6) In the T/M case 12, each of the ribs 28a to 28g that define the shaft direction concave portions 25a to 25g and each of the ribs 29a to 29d and 29g to 29i, other than the left and right paired ribs 29e and 29f that extend toward the lower vertical direction, out of the ribs 29a to 29i that define the radial direction concave portions 27a to 27i are formed at corresponding locations in the circumferential direction of the boss portion 18. In other words, the ribs 28a to 28g and the ribs 29a to 29d and 29g to 29i formed at locations corresponding to each other are continuously formed linearly in the shaft direction with the separating wall 26 as a border. Therefore, because the ribs are formed continuously, the strength of the T/M case 12 can be enhanced.

(7) In the T/M case 12, the thinning portion 30, with a shape corresponding to that of the area of the inner circumference of the boss portion 18 in which the through-hole 19 and the shoulder 19a are formed, is formed on the inner base surface 27A of the radial direction concave portions 27a to 27i that constitute the second concave portion 27. In other words, a part of the through-hole 19 where the sleeve 22 is positioned has a smaller diameter. However, by forming the thinning portion 30 on the inner base surface 27A of the radial direction concave portions 27a to 27i corresponding to the part of the through-hole 19 where the sleeve 22 is positioned, it is possible to avoid a thicker part. Therefore, also in this regard, forming of a casting cavity in the T/M case 12 and the adapter portion 17 thereof is reduced, and the oil-tightness thereof can be further enhanced.

(8) When a casting cavity is formed specifically in the boss portion 18 that forms the inner base surface 27A of the second concave portion 27, automatic transmission fluid (ATF) that fills a space between the boss portion 18 and the output shaft 20 (of which the oil-tightness is maintained by the seal member 36) leaks from an area where the casting cavity is formed to a side of the second concave portion 27, and thus the oil-tightness is reduced. However, in this regard, as far as the transmission case 12 of the present embodiment is concerned, the frequency of forming of a casting cavity is reduced, with a result that the oil-tightness can be preferably maintained.

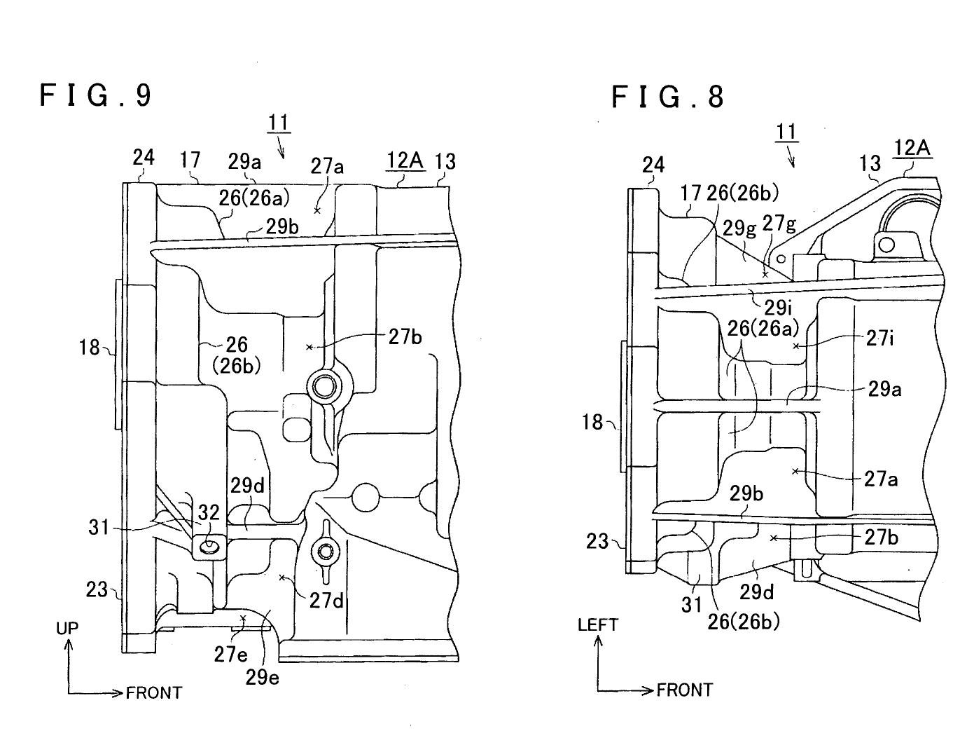

Next, referring to FIGS. 8 and 9, a T/M case 12A according to a second embodiment will be described by mainly discussing the points that differ from the first embodiment.

The T/M case 12A according to the second embodiment, as shown in FIGS. 8 and 9, is structured differently from the T/M case 12 according to the first embodiment, in that the horizontal ribs 29c and 29h that divide the second concave portion 27 into upper and lower portions on both the left and right sides of the outer circumference of the adapter portion 17 are omitted, compared to the TIM case 12 according to the first embodiment.

In the T/M case 12A according to the second embodiment, the shape of the separating wall 26 that separates in the shaft direction the first concave portion 25 constituting the shaft direction concave portions 25a to 25g and the second concave portion 27 constituting the radial direction concave portions 27a to 27i partially differs from that of the separating wall 26 in the T/M case 12 according to the first embodiment. Specifically, the separating wall 26 in the T/M case 12A according to the second embodiment includes a first separating wall portion 26a and a second separating wall portion 26b that are staggered in the shaft direction.

For example, as shown in FIGS. 8 and 9, the first separating wall portion 26a separating between the shaft direction concave portion 25a (see FIG. 5) and the radial direction concave portion 27a in the separating wall 26 is closer to the power input side of the power transmission mechanism 15 in the shaft direction, than the second separating wall portion 26b separating between the shaft direction concave portion 25b (see FIG. 5) and the radial direction concave portion 27b. In the circumferential direction of the boss portion 18, the first separating wall portion 26a and the second separating wall portion 26b are provided next to each other, and the first separating wall portion 26a is at a position higher than the second separating wall portion 26b. Similarly, the first separating wall portion 26a separating between the shaft direction concave portion 25g (see FIG. 5) and the radial direction concave portion 27i in the separating wall 26 is closer to the power input side of the power transmission mechanism 15 in the shaft direction, than the second separating wall portion 26b separating between the shaft direction concave portion 25f (see FIG. 5) and the radial direction concave portion 27g. In the circumferential direction of the boss portion 18, the first separating wall portion 26a and the second separating wall portion 26b are provided next to each other, and the first separating wall portion 26a is at a position higher than the second separating wall portion 26b.

Therefore, according to the present embodiment, additionally to the advantageous effects (1) to (8) according to the first embodiment, the following advantageous effects may be obtained.

(9) Various forces having different directional components operated from a vehicle-mounted engine are applied to the automatic transmission 11. In this case, when a peak of vibration caused by having the T/M cases 12 and 12A stressed to bend and a peak of vibration caused by having the T/M cases 12 and 12A stressed to twist are synchronized, there is a concern that the T/M cases 12 and 12A may resonate. In this regard, in the T/M case 12A according to the present embodiment, the separating wall 26 is structured in such a shape that the separating wall 26 includes the first separating wall portion 26a that is located more forward that is on the power input side of the power transmission mechanism 15 in the shaft direction and the second separating wall portion 26b that is located more rearward that is on the power output side of the power transmission mechanism 15 than the first separating wall portion 26a. Therefore, by having the separating wall 26 with such a characteristic shape, resonance of the T/M case 12A can be suppressed. In the case of the T/M case 12A shown in FIGS. 8 and 9, a resonance-suppressing effect is expected.

(10) In the T/M case 12A, the ribs 29c and 29h that extend horizontally on the outer circumference of the adapter portion 17 on both sides thereof are omitted, and therefore the weight is further reduced by an amount corresponding to the omitted ribs 29c and 29h.

It should be noted that the aforementioned structure may be modified as described bellow.

The thinning portion 30 is not necessarily formed on the inner base surface 27A of each of the radial direction concave portions 27a to 27i that constitute the second concave portion 27.

All of the ribs 28a to 28g that divide the first concave portion 25 and of the ribs 29a to 29d and 29g to 29i that divide the second concave portion 27 are not necessarily formed continuously linear to each other in the shaft direction with the separating wall 26 as a border.

The number of the ribs 28a to 28g and 29a to 29i that are formed on the adapter portion 17 may be different from that of the aforementioned embodiments.

The ribs 29c and 29h that extend in a horizontal direction are omitted, however, for example any of the other ribs 29a, 29b, 29d, 29e, 29f, 29g, 29i may be omitted instead.

In at least one of the first concave portion 25 and the second concave portion 27, the ribs 28a to 28g and 29a to 29i that divide the concave portions into the shaft direction concave portions 25a to 25g and into the radial direction concave portions 27a to 27i are not necessarily formed.

According to an exemplary aspect of the invention, the weight is reduced by the second concave portion along the radial direction of the shaft, and therefore the depth of the concave portion formed for reducing the thickness of the wall can be shallower compared to a case where the weight is reduced only by the first concave portion along the shaft direction. Accordingly, the weight is reduced and, at the same time, enough strength is retained. The first and second concave portions are formed by using dies having different die cutting directions, and therefore each of the die cores used for forming the concave portions can be short. Thus, a cooling passage that reaches an area adjacent to the distal portion of the core can be formed; therefore a seizure at the time of die-cast molding can be suppressed. At the same time, as far as an inner surface of each concave portion is concerned, a taper surface spreading toward the die cutting direction can be short and a thick part is hardly formed, reducing the likelihood of generation of a casting cavity.

According to an exemplary aspect of the invention, the strength is enhanced because of each of the ribs that divide the first concave portion into a plurality of shaft direction concave portions in the circumferential direction of the boss portion.

According to an exemplary aspect of the invention, the strength is enhanced because of each of the ribs that divide the second concave portion into a plurality of radial direction concave portions in the circumferential direction of the boss portion.

According to an exemplary aspect of the invention, the ribs that are correspondingly located in the circumferential direction of the boss portion with the separating wall therebetween as a border are formed continually in the shaft direction, and therefore the strength is expected to be further enhanced by the continually formed ribs.

According to an exemplary aspect of the invention, because the separating wall has the first and the second separating wall portions that are staggered in the shaft direction, the separating wall with such a shape contributes to an enhancement of the strength. At the same time, the resonance can be suppressed by having the peaks of vibrations caused by a bending force applied to the transmission case and by a twisting force thereto staggered from each other.

According to an exemplary aspect of the invention, a preferred resonance suppressing effect can be expected.

According to an exemplary aspect of the invention, a portion of the adapter portion other than the boss portion, the separating wall, and the cylindrical portion is a portion of which the thickness is thus reduced, with the first and the second concave portions, for example, and therefore the weight is effectively saved for convenient handling.

According to an exemplary aspect of the invention, in an adjacent area of the inner base surface of the second concave portion, formation of a thick part is suppressed, and thus forming of a casting cavity can be suppressed.

According to an exemplary aspect of the invention, oil is appropriately fed from the space, rendered oil-tight by the seal member between the boss portion and the output shaft to an area where lubrication is required. In the aforementioned structure, a casting cavity formed in a part of the boss portion that forms the inner base surface of the second concave portion can lower oil-tightness. In the transmission case of the present invention, however, the frequency of forming a casting cavity is reduced as described above, and therefore the oil-tightness is preferably maintained.

What is claimed is:

1. A transmission case that is capable of housing a power transmission mechanism that includes an output shaft that extends along a shaft direction, the transmission case comprising:
a first case body having a cylindrical shape along the shaft direction with the power transmission mechanism capable of being housed in the first case body; and
an adapter portion integrally formed with the first case body that is capable of connecting with a second case body at a rear end of the first case body, which is on a power output side of the power transmission mechanism, wherein the adapter portion includes:
a boss portion through which the output shaft is inserted,
a first concave portion provided on an outer peripheral side of the boss portion and open rearward in the shaft direction, which is on the power output side of the power transmission mechanism, and
a second concave portion open outward in a radial direction of the boss portion with the second concave portion separated in the shaft direction from the first concave portion by a separating wall.

2. The transmission case according to claim 1, wherein the first concave portion is divided into a plurality of shaft direction concave portions separated in a circumferential direction of the boss portion by a plurality of ribs extending along the shaft direction.

3. The transmission case according to claim 1, wherein the second concave portion is divided into a plurality of radial direction concave portions separated in a circumferential direction of the boss portion by a plurality of ribs extending along the shaft direction.

4. The transmission case according to claim 1, wherein:
the first concave portion is divided into a plurality of shaft direction concave portions separated in a circumferential direction of the boss portion by a plurality of ribs extending along the shaft direction,
the second concave portion is divided into a plurality of radial direction concave portions separated in the circumferential direction of the boss portion by a plurality of ribs extending in the shaft direction, and
at least one of the ribs that define the shaft direction concave portions and at least one of the ribs that define the radial direction concave portions are correspondingly located in the circumferential direction of the boss portion with the separating wall therebetween as a border.

5. The transmission case according to claim 4, wherein the separating wall comprises a first separating wall portion and a second separating wall portion that are staggered in the shaft direction.

6. The transmission case according to claim 5, wherein:
the first separating wall portion and the second separating wall portion are provided next to each other along the circumferential direction of the boss portion,
the first separating wall portion is at a position higher than the second separating wall portion, and
the first separating wall portion is closer to a power input side of the power transmission mechanism.

7. The transmission case according to claim 6, wherein from a rear end wall of the first case body that serves as a border with the adapter portion:
the boss portion extends rearward in the shaft direction,
the separating wall extends outward in the radial direction from an outer circumference surface of the boss portion, and
a cylindrical portion, which serves as a joint area for the second case body, extends rearward in the shaft direction from an outer circumference of the separating wall, wherein:
the separating wall forms an inner base surface of the first concave portion and the boss portion and the cylindrical portion form at least a part of an inner surface of the first concave portion, and
the boss portion forms an inner base surface of the second concave portion and the separating wall and the rear end wall of the first case body form at least a part of an inner surface of the second concave portion.

8. The transmission case according to claim 7, wherein:
an inner circumference of the boss portion has an area with a smaller diameter where a shoulder protrudes, and
an inner base surface of the second concave portion is formed with a shape corresponding to a shape of the area with the smaller diameter where the shoulder protrudes on the inner circumference of the boss portion.

9. The transmission case according to claim 8, wherein, on a position more rearward in the shaft direction than the shoulder in the inner circumference of the boss portion, a seal member is mounted for making a space between the boss portion and the output shaft oil-tight.

10. The transmission case according to claim 1, wherein the separating wall comprises a first separating wall portion and a second separating wall portion that are staggered in the shaft direction.

11. The transmission case according to claim 10, wherein:
the first separating wall portion and the second separating wall portion are provided next to each other along a circumferential direction of the boss portion,
the first separating wall portion is at a position higher than the second separating wall portion, and
the first separating wall portion is closer to a power input side of the power transmission mechanism.

12. The transmission case according to claim 1, wherein from a rear end wall of the first case body that serves as a border with the adapter portion:
the boss portion extends rearward in the shaft direction,
the separating wall extends outward in the radial direction from an outer circumference surface of the boss portion, and
a cylindrical portion, which serves as a joint area for the second case body, extends rearward in the shaft direction from an outer circumference of the separating wall, wherein:
the separating wall forms an inner base surface of the first concave portion and the boss portion and the cylindrical portion form at least a part of an inner surface of the first concave portion, and
the boss portion forms an inner base surface of the second concave portion and the separating wall and the rear end wall of the first case body form at least a part of an inner surface of the second concave portion.

13. The transmission case according to claim 12, wherein:
an inner circumference of the boss portion has an area with a smaller diameter where a shoulder protrudes, and
an inner base surface of the second concave portion is formed with a shape corresponding to a shape of the area with the smaller diameter where the shoulder protrudes on the inner circumference of the boss portion.

14. The transmission case according to claim 13, wherein on a position more rearward in the shaft direction than the shoulder in the inner circumference of the boss portion, a seal member is mounted for making a space between the boss portion and the output shaft oil-tight.

15. A method of forming a transmission case with a first case body having a cylindrical shape and an adapter portion integrally formed with the first case body that is capable of connecting with a second case body at a rear end of the first case body, comprising:
moving a front forming die relative to a rear forming die;
moving an upper forming die relative to the front forming die and the rear forming die; and
filling a cavity formed by the front forming die, the rear forming die and the upper forming die in order to form:
a boss portion,
a first concave portion provided on an outer peripheral side of the boss portion and open rearward, and
a second concave portion open outward in a radial direction of the boss portion with the second concave portion separated from the first concave portion by a separating wall.

16. The method of claim 15, wherein at least one cooling passage is formed in at least one of the front forming die, the rear forming die and the upper forming die.

17. A case, comprising:
a first case body having a cylindrical shape; and
an adapter portion integrally formed with the first case body that is capable of connecting with a second case body at a rear end of the first case body, wherein the adapter portion includes:
a boss portion,
a first concave portion provided on an outer peripheral side of the boss portion and open rearward, and
a second concave portion open outward in a radial direction of the boss portion with the second concave portion separated from the first concave portion by a separating wall.

18. The case according to claim 17, wherein the first concave portion is divided into a plurality of concave portions separated in a circumferential direction of the boss portion by a plurality of ribs.

19. The case according to claim 17, wherein the second concave portion is divided into a plurality of concave portions separated in a circumferential direction of the boss portion by a plurality of ribs.

20. The case according to claim 17, wherein the case is a transmission case with a power transmission mechanism that includes an output shaft.
